(19) United States
(12) Patent Application Publication
(10) Pub. No.: US 2026/0204256 A1
(43) Pub. Date: Jul. 16, 2026

(54) SYSTEM AND METHOD FOR INTERACTING WITH ADULT TOY USING MULTIMEDIA

(71) Applicant: PURE IMAGINATION AI PTE. LTD., CENTRAL REGION (SG)

(72) Inventor: YING LI, Lianyungang (CN)

(21) Appl. No.: 19/026,379

(22) Filed: Jan. 17, 2025

(30) Foreign Application Priority Data
Dec. 10, 2024 (CN) 202411806608.3

(51) Int. Cl. G10L 15/22

(52) U.S. Cl. CPC G10L 15/22; G10L 2015/223

(57) ABSTRACT

The present disclosure provides a system and method for interacting with an adult toy using multimedia, falling within the technical field of adult products. The system includes a user terminal, a local multimedia module, a network communication module, a server module and a toy module. In the present disclosure, with a design of the local multimedia module that can be used off-line, a user can access multimedia content, including audio and video, from the user terminal, and the multimedia content can render a user's use scene and induce a voice interaction between the user and the local multimedia module. A voice interaction unit in the local multimedia module recognizes the user's voice content and generates an instruction, and the instruction is transmitted back to the user terminal and sent to the toy module for execution, enhancing interactivity and playability of the adult toy.

### CROSS-REFERENCE TO RELATED APPLICATION

This application claims priority of Chinese Patent Application No. 202411806608.3, filed on Dec. 10, 2024, the entire contents of which are incorporated herein by reference.

### TECHNICAL FIELD

The present disclosure is in the technical field of adult products, and more particularly relates to a system and method for interacting with an adult toy using multimedia.

### BACKGROUND

Adult toys refer to some auxiliary articles that help adults get sexual assistance, not only adding sexual interest and improving the quality of sexual love, but also bringing positive effects on sexual health.

At present, for the control of adult toys, there are buttons on the adult toys, and clicking the buttons directly controls the toys. Alternatively, through a control terminal (such as a mobile phone APP), an interface on the control terminal is operated to release a control instruction. However, these cannot produce an interactive effect on users, resulting in poor playability of the adult toys.

### SUMMARY

An objective of the present disclosure is to provide a system and method for interacting with an adult toy using multimedia to solve the above-mentioned problems.

On the one hand, to achieve the above objective, the present disclosure adopts the following technical solutions. A system for interacting with an adult toy using multimedia includes a user terminal, a local multimedia module, a network communication module, a server module and a toy module. A wired and/or wireless communication connection is established between the user terminal and the local multimedia module, the local multimedia module is connected to the server module via the network communication module, and the user terminal is connected to the toy module in a communication way; and the user terminal is capable of accessing multimedia content in the local multimedia module and establishing voice interaction with the local multimedia module, a voice interaction unit in the local multimedia module recognizes the voice content of a user and generates an instruction, and the instruction is transmitted back to the user terminal and sent to the toy module for execution.

In a further description of the above technical solution:
an instruction set updating unit is arranged in the server module.

In a further description of the above technical solution:
the local multimedia module includes a video unit and an audio unit;

The video unit delivers motion changes of a video picture to a model for analysis via an image recognition technology, then performs down-sampling processing on the model recognition results, and realizes smooth transition optimization of a curve via a higher-order function. The optimized curve is mapped to an intensity value range supported by the toy. Finally, a group of sampling intensity values based on a time sequence is generated, and is converted into a Bluetooth command sequence executable by the toy, realizing accurate motion control.

The audio unit delivers the audio features including tempo, volume and timbre of an audio file to the model for analysis, extracts key features and performs fusion processing on the recognition results, and uses methods including down-sampling and higher-order function processing to realize smooth transition optimization of a curve, making data more suitable for subsequent applications. The optimized curve is mapped to an intensity value range supported by the toy. Finally, a group of sampling intensity values based on a time sequence is generated, and is converted into a Bluetooth command sequence executable by the toy, realizing accurate motion control.

In a further description of the above technical solution:
the user terminal is connected to the local multimedia module and the toy module through Bluetooth.

In a further description of the above technical solution:
a toy type recognition unit is arranged in the user terminal.

On the other hand, in order to achieve the above objective, the present disclosure adopts the following method. A method for interacting with an adult toy using multimedia includes the steps of:
1) accessing the audio and video in the local multimedia module through the user terminal when the user uses the toy module, and establishing a voice conversation between the user and the voice interaction unit at this time;
2) recognizing a type of the toy model by the toy type recognition unit in the user terminal, and sending type information to the voice interaction unit;
3) recognizing the voice content of the user by the voice interaction unit and generating a corresponding instruction of the toy model of this type, and transmitting the instruction back to the user terminal and sending the same to the toy module for execution;
4) accessing the instruction set updating unit by the voice interaction unit via the network communication module to update the instruction when there is no instruction corresponding to the toy model of this type in the voice interaction unit; and
5) accessing the server module by the voice interaction unit via the network communication module, and upgrading itself to an intelligent voice module with a networking function.

In summary, by adopting the technical solutions, the present disclosure has the following advantageous effect.

In the present disclosure, with the design of the local multimedia module that can be used off-line, the user can access multimedia content, including audio and video, from the user terminal, and the multimedia content can render a user's use scene and induce a voice interaction between the user and the local multimedia module. The voice interaction unit in the local multimedia module recognizes the user's voice content and generates an instruction, and the instruction is transmitted back to the user terminal and sent to the toy module for execution, enhancing interactivity and playability of the adult toy.

### BRIEF DESCRIPTION OF THE DRAWINGS

FIG. 1 is a block diagram of a system for interacting with an adult toy using multimedia.

FIG. 2 is a flow diagram of a method for interacting with an adult toy using multimedia.

### DETAILED DESCRIPTION

For clearer objectives, technical solutions and advantages of the examples of the present disclosure, technical solutions in the examples of the present disclosure will be described clearly and completely in the following with reference to the attached drawings in the examples of the present disclosure. Obviously, all the described examples are only some, rather than all examples of the present disclosure. The components of the examples of the present disclosure, which are generally described and illustrated in the attached drawings, may be arranged and designed in a variety of different configurations. Therefore, the following detailed description of the examples of the present disclosure provided in the attached drawings is not intended to limit the scope of the present disclosure as claimed, but is merely representative of selected examples of the present disclosure. On the basis of the examples in the present disclosure, all other examples obtained by those ordinary skilled in the art without creative efforts belong to the protection scope of the present disclosure. It is to be noted that similar reference numbers and letters indicate similar terms in the attached drawings below, and once an item is defined in an accompanying drawing, it does not need to be further defined and explained in subsequent attached drawings. In the description of the present disclosure, it is to be noted that the azimuth or positional relationship indicated by terms “upper” and “inner” is based on the azimuth or positional relationship shown in the attached drawings, or the azimuth or positional relationship that the product of the present disclosure is usually put in use, which is only to facilitate the description of the present disclosure and simplify the description, and does not indicate or imply that the referred device or element must have a specific direction, be constructed and operated in a specific orientation. Therefore, it is not to be understood as a limitation of the present disclosure. In the description of the present disclosure, it is to be noted that, unless expressly specified and limited otherwise, the terms “arranged”, “mounted”, “connected”, and “linked” are to be understood broadly. For example, a connection can be a fixed connection, a detachable connection, and an integral connection; and a direct connection, an indirect connection through an intermediate medium, or internal communication between two elements. For those ordinary skilled in the art, the specific meanings of the above terms in the present disclosure can be understood according to specific situations.

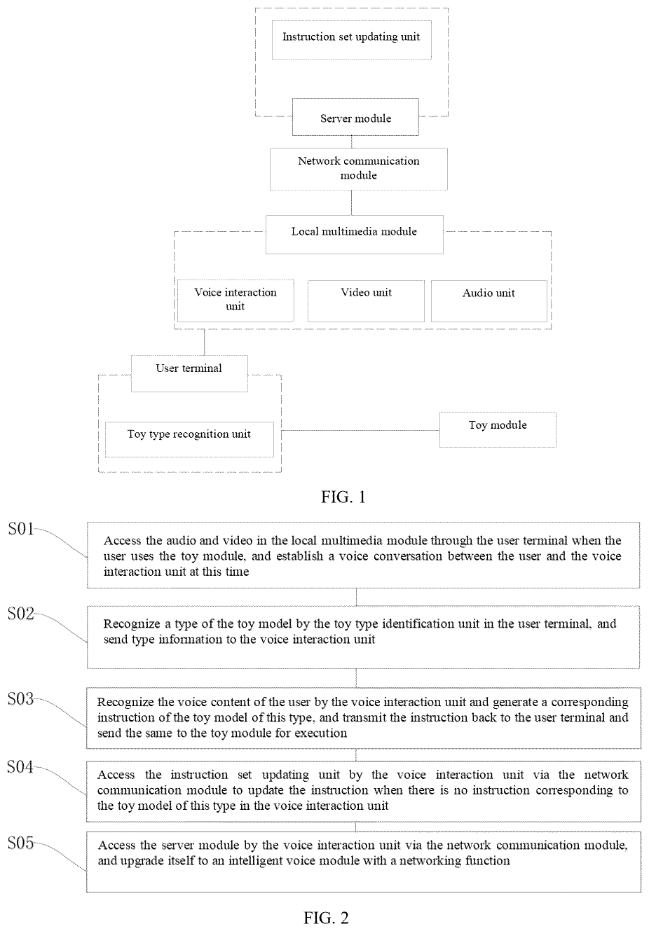

With reference to FIGS. 1 and 2, the present disclosure provides a technical solution. A system for interacting with an adult toy using multimedia includes a user terminal, a local multimedia module, a network communication module, a server module and a toy module. A wired and/or wireless communication connection is established between the user terminal and the local multimedia module, the local multimedia module is connected to the server module via the network communication module, and the user terminal is connected to the toy module in a communication way; and the user terminal is capable of accessing multimedia content in the local multimedia module and establishing voice interaction with the local multimedia module, a voice interaction unit in the local multimedia module recognizes the voice content of a user and generates an instruction, and the instruction is transmitted back to the user terminal and sent to the toy module for execution.

An instruction set updating unit is arranged in the server module.

The local multimedia module includes a video unit and an audio unit.

The video unit delivers motion changes of a video picture to a model for analysis via an image recognition technology, then performs down-sampling processing on the model recognition results, and realizes smooth transition optimization of a curve via a higher-order function. The optimized curve is mapped to an intensity value range supported by the toy. Finally, a group of sampling intensity values based on a time sequence is generated, and is converted into a Bluetooth command sequence executable by the toy, realizing accurate motion control.

The audio unit delivers the audio features including tempo, volume and timbre of an audio file to the model for analysis, extracts key features and performs fusion processing on the recognition results, and uses methods including down-sampling and higher-order function processing to realize smooth transition optimization of a curve, making data more suitable for subsequent applications. The optimized curve is mapped to an intensity value range supported by the toy. Finally, a group of sampling intensity values based on a time sequence is generated, and is converted into a Bluetooth command sequence executable by the toy, realizing accurate motion control.

The user terminal is connected to the local multimedia module and the toy module through Bluetooth.

A toy type recognition unit is arranged in the user terminal.

### EXAMPLES

S01: when a user uses the toy module, the user accesses audio and video in the local multimedia module via the user terminal, and at this time, the user establishes a voice conversation with the voice interaction unit. The video unit delivers motion changes of a video picture to a model for analysis via an image recognition technology, then performs down-sampling processing on the model recognition results, and realizes smooth transition optimization of a curve via a higher-order function. The optimized curve is mapped to an intensity value range supported by the toy. Finally, a group of sampling intensity values based on a time sequence is generated, and is converted into a Bluetooth command sequence executable by the toy, realizing accurate motion control. The audio unit delivers the audio features including tempo, volume and timbre of an audio file to the model for analysis, extracts key features and performs fusion processing on the recognition results, and uses methods including down-sampling and higher-order function processing to realize smooth transition optimization of a curve, making data more suitable for subsequent applications. The optimized curve is mapped to an intensity value range supported by the toy. Finally, a group of sampling intensity values based on a time sequence is generated, and is converted into a Bluetooth command sequence executable by the toy, realizing accurate motion control.

S02: the toy type recognition unit in the user terminal recognizes a type of the toy model, and sends type information to the voice interaction unit.

S03: the voice interaction unit recognizes the voice content of the user and generates a corresponding instruction of the toy model of this type, and the instruction is transmitted back to the user terminal and is sent to the toy module for execution.

S04: the voice interaction unit accesses the instruction set updating unit via the network communication module to update the instruction when there is no instruction corresponding to the toy model of this type in the voice interaction unit.

S05: the voice interaction unit accesses the server module via the network communication module, and upgrades itself to an intelligent voice module with a networking function.

All the above are only the preferred examples of the present disclosure, but the scope of protection of the present disclosure is not limited to this. Within the technical scope disclosed by the present disclosure, any equivalent replacements or changes made by those skilled familiar with the technical field according to the technical solution and inventive concept of the present disclosure are to be included in the scope of protection of the present disclosure.

1. A system for interacting with an adult toy using multimedia, comprising a user terminal, a local multimedia module, a network communication module, a server module and a toy module, wherein a wired and/or wireless communication connection is established between the user terminal and the local multimedia module, the local multimedia module is connected to the server module via the network communication module, and the user terminal is connected to the toy module in a communication way; and the user terminal is capable of accessing multimedia content in the local multimedia module and establishing voice interaction with the local multimedia module, a voice interaction unit in the local multimedia module recognizes the voice content of a user and generates an instruction, and the instruction is transmitted back to the user terminal and sent to the toy module for execution.

2. The system for interacting with an adult toy using multimedia according to claim 1, wherein an instruction set updating unit is arranged in the server module.

3. The system for interacting with an adult toy utilizing multimedia according to claim 1, wherein the local multimedia module comprises a video unit and an audio unit.

4. The system for interacting with an adult toy using multimedia according to claim 1, wherein the user terminal is connected to the local multimedia module and the toy module through Bluetooth.

5. The system for interacting with an adult toy using multimedia according to claim 1, wherein a toy type recognition unit is arranged in the user terminal.

6. A method for interacting with an adult toy using multimedia according to claim 1, comprising the steps of:
1) accessing the audio and video in the local multimedia module through the user terminal when the user uses the toy module, and establishing a voice conversation between the user and the voice interaction unit at this time;
2) recognizing a type of a toy model by the toy type recognition unit in the user terminal, and sending type information to the voice interaction unit;
3) recognizing the voice content of the user by the voice interaction unit and generating a corresponding instruction of the toy model of this type, and transmitting the instruction back to the user terminal and sending the same to the toy module for execution;
4) accessing the instruction set updating unit by the voice interaction unit via the network communication module to update the instruction when there is no instruction corresponding to the toy model of this type in the voice interaction unit; and
5) accessing the server module by the voice interaction unit via the network communication module, and upgrading itself to an intelligent voice module with a networking function.

7. A method for interacting with an adult toy using multimedia according to claim 2, comprising the steps of:
1) accessing the audio and video in the local multimedia module through the user terminal when the user uses the toy module, and establishing a voice conversation between the user and the voice interaction unit at this time;
2) recognizing a type of a toy model by the toy type recognition unit in the user terminal, and sending type information to the voice interaction unit;
3) recognizing the voice content of the user by the voice interaction unit and generating a corresponding instruction of the toy model of this type, and transmitting the instruction back to the user terminal and sending the same to the toy module for execution;
4) accessing the instruction set updating unit by the voice interaction unit via the network communication module to update the instruction when there is no instruction corresponding to the toy model of this type in the voice interaction unit; and
5) accessing the server module by the voice interaction unit via the network communication module, and upgrading itself to an intelligent voice module with a networking function.

8. A method for interacting with an adult toy using multimedia according to claim 3, comprising the steps of:
1) accessing the audio and video in the local multimedia module through the user terminal when the user uses the toy module, and establishing a voice conversation between the user and the voice interaction unit at this time;
2) recognizing a type of a toy model by the toy type recognition unit in the user terminal, and sending type information to the voice interaction unit;
3) recognizing the voice content of the user by the voice interaction unit and generating a corresponding instruction of the toy model of this type, and transmitting the instruction back to the user terminal and sending the same to the toy module for execution;
4) accessing the instruction set updating unit by the voice interaction unit via the network communication module to update the instruction when there is no instruction corresponding to the toy model of this type in the voice interaction unit; and
5) accessing the server module by the voice interaction unit via the network communication module, and upgrading itself to an intelligent voice module with a networking function.

9. A method for interacting with an adult toy using multimedia according to claim 4, comprising the steps of:
1) accessing the audio and video in the local multimedia module through the user terminal when the user uses the toy module, and establishing a voice conversation between the user and the voice interaction unit at this time;
2) recognizing a type of a toy model by the toy type recognition unit in the user terminal, and sending type information to the voice interaction unit;
3) recognizing the voice content of the user by the voice interaction unit and generating a corresponding instruction of the toy model of this type, and transmitting the instruction back to the user terminal and sending the same to the toy module for execution;
4) accessing the instruction set updating unit by the voice interaction unit via the network communication module to update the instruction when there is no instruction corresponding to the toy model of this type in the voice interaction unit; and
5) accessing the server module by the voice interaction unit via the network communication module, and upgrading itself to an intelligent voice module with a networking function.

10. A method for interacting with an adult toy using multimedia according to claim 5, comprising the steps of:
1) accessing the audio and video in the local multimedia module through the user terminal when the user uses the toy module, and establishing a voice conversation between the user and the voice interaction unit at this time;
2) recognizing a type of a toy model by the toy type recognition unit in the user terminal, and sending type information to the voice interaction unit;
3) recognizing the voice content of the user by the voice interaction unit and generating a corresponding instruction of the toy model of this type, and transmitting the instruction back to the user terminal and sending the same to the toy module for execution;
4) accessing the instruction set updating unit by the voice interaction unit via the network communication module to update the instruction when there is no instruction corresponding to the toy model of this type in the voice interaction unit; and
5) accessing the server module by the voice interaction unit via the network communication module, and upgrading itself to an intelligent voice module with a networking function.
